(19) United States
(12) Patent Application Publication
(10) Pub. No.: US 2002/0123938 A1
(43) Pub. Date: Sep. 5, 2002

(54) Systems and methods to facilitate a transaction wherein a purchaser is associated with an approver

(76) Inventors: Philip S. Yu, Chappaqua, NY (US); Edith H. Stern, Yorktown Heights, NY (US); Barry E. Willner, Briarcliff Manor, NY (US); David P. Greene, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 09/797,123

(22) Filed: Mar. 1, 2001

(51) Int. Cl. G06F 17/60

(52) U.S. Cl. 705/26

(57) ABSTRACT

Systems and methods are provided to facilitate a transaction wherein a purchaser is associated with an approver. For example, a consumer purchaser may request an item from a merchant. The merchant may then transmit information to the associated approver, such as by sending an electronic mail message to child's parent. If the approver approves the transaction, the item is provided to the purchaser.

### FIELD

The present invention relates to transaction systems. In particular, the present invention relates to systems and methods to facilitate a transaction wherein a purchaser is associated with an approver.

### BACKGROUND

A party, such as a consumer or a business, will often like to have some control over the transactions that are made by other parties. For example, the party may be responsible for the transactions that are made by other parties—such as a parent who must pay for items purchased by his or her children or an employer that must pay for items purchased by employees.

It is known that a party, such as an employer, can implement a procedure in an attempt to control transactions that are made by other parties. For example, an employer may establish a workflow procedure that requires an employee to receive approval from a manager before purchasing an item (e.g., either verbally or by having the manager sign an appropriate form). Such procedures can also be implemented using software programs that exchange information via computer networks. For example, an employee may complete an electronic form by describing an item that he or she wishes to purchase. Information about the item is then is then displayed (via another electronic form) to a manager who can approve the transaction. Only after the transaction is approved by the manager is the employee allowed to purchase the item. In this way, the manager can prevent employees from purchasing unnecessary items. However, even with such a workflow procedure an employer may find that an employee has purchased an item without receiving the necessary approval.

Moreover, there are many circumstances where such a workflow procedure will be impractical. For example, there would be no easy way for a family to implement or enforce a workflow procedure similar to ones that are used by employers. That is, the cost and complexity of such a system will not justify its use by the family. Similarly, a small business may be unable to provide the software programs and computer networks needed to implement such a system. Note that this will be the case even if the family or the small business purchases items from a relatively small set of merchants (e.g., STAPLES® and HOME DEPOT®) and/or uses a single form of payment for those purchases (e.g., an AMERICAN EXPRESS® credit card).

### SUMMARY

To alleviate problems inherent in the prior art, the present invention introduces systems and methods to facilitate a transaction wherein a purchaser is associated with an approver.

One embodiment of the present invention is directed to a merchant authorization device associated with a merchant. According to this embodiment, the merchant authorization device receives a request by a consumer purchaser to purchase an item from the merchant. It is then arranged via the merchant authorization device for a consumer approver associated with the consumer purchaser to receive information about the request.

Another embodiment of the present invention is directed to a computer implemented method of facilitating a transaction via a merchant authorization device associated with a merchant. According to this embodiment, the merchant authorization device receives a request by a first consumer to receive an item from the merchant, the request being received via a communication network. A second consumer is then determined based on the first consumer. A transaction rule is also determined, and information associated with the transaction is evaluated based on the transaction rule. Based on the evaluation, information about the request is transmitted from the merchant authorization device to a second consumer. An indication of approval is received from the second consumer, and it is arranged for the item to be provided to the first consumer based on the received approval.

Another embodiment of the present invention is directed to a method of facilitating a transaction via an authorization service device associated with a plurality of merchants. According to this embodiment, the authorization service device receives information associated with a request by a purchaser to purchase an item from one of the plurality of merchants. It is then arranged for an approver associated with the purchaser to receive information about the request.

Another embodiment of the present invention is directed to a method of facilitating a transaction via a payment processing device associated with a plurality of merchants. According to this embodiment, the payment processing device receives information associated with a request by a purchaser to purchase an item from one of the plurality of merchants. Information associated with the request is then transmitted to an approver associated with the purchaser.

One embodiment of the present invention comprises: means for receiving at a merchant authorization device a request by a consumer purchaser to purchase an item from a merchant; and means for arranging via the merchant authorization device for a consumer approver associated with the consumer purchaser to receive information about the request.

Another embodiment comprises: means for receiving at a merchant authorization device a request by a first consumer to receive an item from a merchant, the request being received via a communication network; means for determining a second consumer based on the first consumer; means for determining a transaction rule; means for evaluating information associated with the transaction based on the transaction rule; means for transmitting information about the request from the merchant authorization device to a second consumer device based on the evaluation; means for receiving an indication of approval from the second consumer device; and means for arranging for the item to be provided to the first consumer based on the received approval.

Another embodiment comprises: means for receiving at an authorization service device information associated with a request by a purchaser to purchase an item from one of a plurality of merchants; and means for arranging for an approver associated with the purchaser to receive information about the request.

Another embodiment comprises: means for receiving at a payment processing device information associated with a request by a purchaser to purchase an item from one of a plurality of merchants; and means for transmitting information associated with the request to an approver associated with the purchaser.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram of a transaction performed according to an embodiment of the present invention.

FIG. 2 is a block diagram overview of a transaction system according to the embodiment of the present invention shown in FIG. 1.

FIG. 3 is a flow chart of a method according to the embodiment of the present invention shown in FIG. 1.

FIG. 4 is an information flow diagram of a transaction performed according to another embodiment of the present invention.

FIG. 5 is a block diagram overview of a transaction system according to the embodiment of the present invention shown in FIG. 4.

FIG. 6 is a flow chart of a method according to the embodiment of the present invention shown in FIG. 4.

FIG. 7 is an information flow diagram of a transaction performed according to still another embodiment of the present invention.

FIG. 8 is a block diagram overview of a transaction system according to the embodiment of the present invention shown in FIG. 7.

FIG. 9 is a flow chart of a method according to the embodiment of the present invention shown in FIG. 7.

FIG. 10 is a block diagram of an authorization device according to an embodiment of the present invention.

FIG. 11 is a tabular representation of a portion of an approver database according to an embodiment of the present invention.

FIG. 12 is a tabular representation of a portion of a purchaser database according to an embodiment of the present invention.

FIG. 13 is a tabular representation of a record in a transaction database according to an embodiment of the present invention.

FIG. 14 is a flow chart of a method according to another embodiment of the present invention.

FIG. 15 is an approver device displaying information according to an embodiment of the present invention.

### DETAILED DESCRIPTION

Embodiments of the present invention may be associated with a transaction in which an “item” is purchased from a “merchant.” As used herein, the term “item” refers to anything (e.g., a product, a service, or an interest in a product or service) that may be purchased or received. Examples of items include books, grocery items, emergency automobile towing services, software program licenses, and airline tickets.

As used herein, the term “merchant” refers to any party that may sell or provide an item. A merchant may be, for example, a business that sells or provides an item (e.g., MACY'S® or AMAZON.COM®), an individual, or a business that arranges for an item to be sold or provided (e.g., EBAY.COM®).

Moreover, embodiments of the present invention involve a “purchaser” and an “approver.” As used herein, the term “purchaser” refers to any party who may purchase or request to receive an item, such as a child who purchases a book from a merchant (e.g., using his or her parents' credit card account to pay for the book) or an employee who orders office supplies. As used herein, the term “approver” may refer to, for example, a party who is associated with a purchaser and who can approve (or decline to approve) a purchaser's request. A purchaser and/or an approver may comprise, for example, an consumer or a business.

Some embodiments of the present invention involve a “consumer” purchaser and/or a “consumer” approver. As used herein, the term “consumer” refers to an individual who may participate in transactions (e.g., and not a business). For example, a consumer purchaser may comprise an individual who requests to receive an item for his or her own use.

Consumer Approver Embodiment

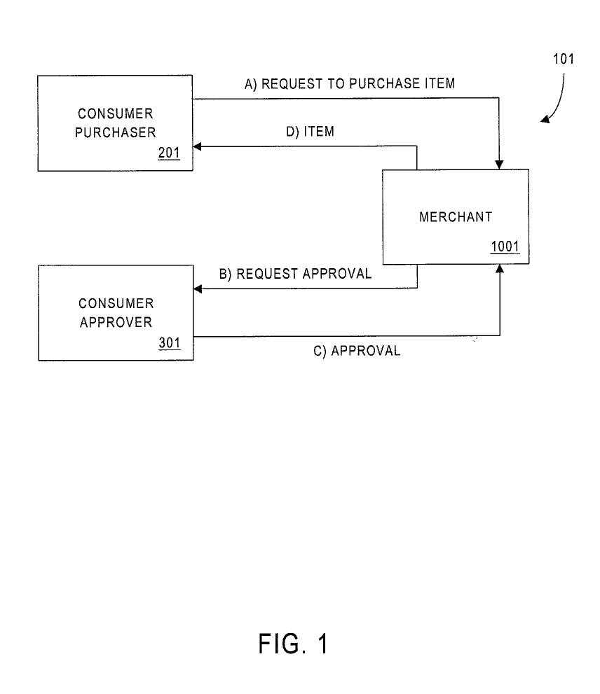

Turning now in detail to the drawings, FIG. 1 is an information flow diagram of a transaction 101 performed according to an embodiment of the present invention wherein a consumer approver 301 is associated with a consumer purchaser 201.

At (A), the consumer purchaser 201 provides to a merchant 1001 a request to purchase or receive an item. For example, a child may attempt to purchase a book from the merchant 1001 using an account associated with his or her parents (e.g., a merchant account or a credit card account).

According to this embodiment of the present invention, the merchant 1001 attempts to authorize the transaction by requesting approval for the transaction from a consumer approver 301 at (B). For example, the merchant 1001 may attempt to authorize the transaction by sending information about the transaction to a child's parent (e.g. indicating the item and a cost associated with the item). According to one embodiment, the merchant 1001 also evaluates a transaction rule to determine if the transaction needs to be authorized (e.g., only transactions having a cost over a threshold amount may need to be authorized by a child's parent). Note that, in this case, different consumer purchasers 201 and/or different consumer approvers 301 may be associated with different transaction rules.

If the consumer approver 301 does not approve the transaction, the merchant may 1001 decline to provide the item to the consumer purchaser 201. According to another embodiment, the merchant 1001 instead provides the item to the consumer purchaser 201 unless a specific indication is received from the consumer approver 301 that the transaction should not be completed (e.g., if the merchant 1001 does not receive any response from the consumer approver 301 within a predetermined period of time).

If the consumer approver 301 provides an indication of approval to the merchant 1001 at (C), the merchant 1001 proceeds with the transaction by providing the item to the consumer purchaser 201 at (D). For example the merchant 1001 may provide a book to a child (e.g., by providing the book directly to the child at a retail store or by arranging for the book to be delivered to an address associated with child).

The merchant 1001 may also arrange to receive payment in exchange for the item. For example, the merchant 1001 may arrange for the consumer approver 301 to provide payment in exchange for the item.

Note that a single consumer approver 301 may be associated with multiple consumer purchasers 201. Similarly, a single consumer purchaser 201 may be associated with multiple consumer approvers 301 (e.g., an approval from a mother and a father may be required).

In this way, the consumer approver 301 can let the consumer purchaser 201 initiate transactions while still maintaining some control over the transactions that are completed. Moreover, the consumer approver 301 can exercise this control without installing an elaborate workflow system in his or her home.

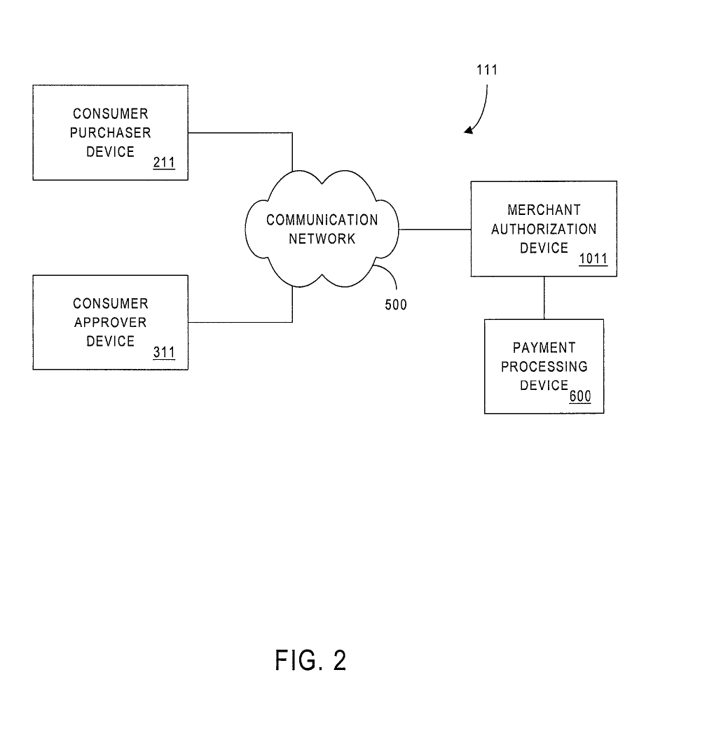

FIG. 2 is a block diagram of an transaction system 111 according to the embodiment of the present invention shown in FIG. 1. The transaction system 111 includes a merchant authorization device 1011, associated with a merchant, in communication with a consumer purchaser device 211. As used herein, devices (such as the merchant authorization device 1011 and the consumer purchaser device 211) may communicate, for example, via a communication network 500, such as an Ethernet network, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet. Moreover, as used herein, communications include those enabled by wired or wireless technology. Note that although a single merchant authorization device 1011 is shown in FIG. 2, any number of merchant authorization devices 1011 may be included in the transaction system 111. Similarly, any number of the other devices described herein may be included in the transaction system 111 according to embodiments of the present invention.

In one embodiment of the present invention, a consumer purchaser device 211 communicates with a remote, Web-based merchant authorization device 1011 (e.g., a server) via the Internet. For example, a consumer purchaser may use his or her PC to access a Web site associated with a merchant. Although some embodiments of the present invention are described with respect to information exchanged using a Web site, according to other embodiments information can instead be exchanged, for example, via: a telephone, an Interactive Voice Response Unit (IVRU), electronic mail, and/or a wireless communication system.

According to an embodiment of the present invention, the merchant authorization device 1011 receives a request from the consumer purchaser device 211 to purchase an item from the merchant. For example, a consumer purchaser may use his or her PC to order an item from the merchant via a Web site.

The merchant authorization device 1011 may then determine a consumer approver and/or a consumer approver device 311 associated with the consumer purchaser and/or the consumer purchaser device 211. For example, the merchant authorization device 1011 may use an identifier associated with the consumer purchaser device 211 (e.g., an identifier stored as a “cookie” file on the consumer purchaser device 211) to retrieve an indication of a consumer approver device 311 from a database. According to another embodiment, an indication of the consumer approver and/or the consumer approver device 311 is included in the request received from the consumer purchaser device 211.

The merchant authorization device 1011 then arranges for information about the request to be transmitted to the consumer approver device 311. For example, the merchant authorization device 1011 may transmit the following electronic mail message to the consumer approver device 311: “Your son Billy has submitted a request to purchase the following book from us: Tom Sawyer by Mark Twain ($8.00). Please respond to this message if you want to approve his purchase.”

Note that the merchant authorization device 1011 may communicate with the consumer purchaser device 211 and the consumer approver device 311 via the same communication network 500 or via different communication networks.

According to one embodiment, the merchant authorization device 1011 evaluates information associated with the transaction to determine if approval from the consumer approver device 311 is required. For example, the merchant authorization device 1011 may evaluate a consumer purchaser identifier and/or a consumer approver identifier to determine if a request for approval needs to be sent to the consumer approver device 311 (e.g., some consumer purchasers and/or some consumer approvers may not require approval). Similarly, a transaction rule associated with a consumer purchaser and/or a consumer approver may be evaluated. For example, a consumer approver may indicate that only items over twenty dollars (or a set of items having a total cost of over forty dollars) need to be approved. According to another embodiment, the merchant authorization device 1011 evaluates a series of transactions, such as to determine if a consumer purchaser has purchased over one hundred dollars worth of items in a given month.

According to still another embodiment, the merchant authorization device 1011 evaluates information about the item being purchased. For example, approval may never be required for emergency services (e.g., automobile towing or medical services), school supplies, or food items. Similarly, approval may always be required for other items (e.g., alcohol or entertainment items). Other information about the transaction, such as a merchant, a location, or a time of day, may also be evaluated by the merchant authorization device 1011. According to one embodiment, the evaluation performed by the merchant authorization device 1011 is based on information received from the consumer approver (e.g., a transaction rule) when he or she establishes or updates an account associated with the merchant.

According to still another embodiment, the merchant authorization device 1011 modifies a transaction rule based on a behavior of the consumer purchaser and/or consumer approver. For example, if a consumer approver regularly approves a particular type of transaction by a consumer purchaser (e.g., movie tickets on a weekend), similar transactions may be permitted without authorization in the future.

If the merchant authorization device 1011 receives an indication of approval from the consumer approver device 311, the item is provided to the consumer purchaser.

The consumer purchaser device 211, the consumer approver device 311, and the merchant authorization device 1011 may be any devices capable of performing the various functions described herein. The consumer purchaser device 211 and/or the consumer approver device 311 may be, for example: a PC, a kiosk (e.g., a kiosk located in a merchant's store), a PDA, a wired or wireless telephone, a one-way or two-way pager, or any other appropriate storage and/or communication device.

Note that the devices shown in FIG. 2 need not be in constant communication. For example, a consumer purchaser device 211 might only communicate with the merchant authorization device 1011 when appropriate (e.g., via an infrared device when near a receiving device coupled to the merchant authorization device 1011). Moreover, multiple devices may be incorporated in a single device (e.g., a kiosk or a sales terminal may act as both a consumer purchaser device 211 and a merchant authorization device 1011).

According to one embodiment, the merchant authorization device 1011 also arranges for the merchant to receive payment in exchange for an item. According to such an embodiment, a payment device 600 may be used to arrange for the consumer approver to provide a payment. For example, the merchant authorization device 1011 may arrange for a consumer approver to provide payment for an item via a credit card account, a debit card account, a banking account, or a digital payment protocol. The payment device 600 may comprise, for example, a third party device (e.g., a credit card processing device) and/or a Credit Authorization Terminal (CAT) device.

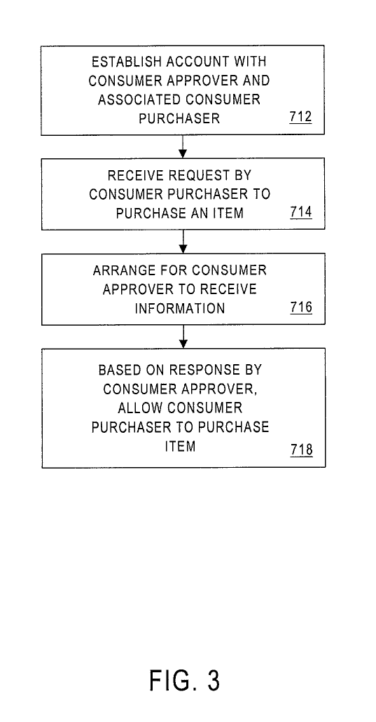

FIG. 3 is a flow chart of a method that may be performed according to the embodiment of the present invention shown in FIG. 1. The method may be performed, for example, by the merchant authorization device 1011. The flow charts in FIG. 3 and the other figures described herein do not imply a fixed order to the steps, and embodiments of the present invention can be practiced in any order that is practicable. Moreover, the method may instead be performed by any of the devices described herein.

At 712, the merchant authorization device 1011 establishes an account with a consumer approver and an associated consumer purchaser. For example, the consumer approver may indicate to the merchant authorization device 1011 one or more associated consumer purchasers and/or transaction rules.

At 714, the merchant authorization device 1011 receives a request by a consumer purchaser to purchase (i.e., receive) an item from a merchant. The merchant authorization device 1011 arranges for a consumer approver, associated with the consumer purchaser, to receive information about the request at 716. Based on a response by the consumer approver, the merchant authorization device 1011 arranges for the item to be provided to the consumer purchaser (or to the consumer approver) at 718.

Authorization Service Embodiment

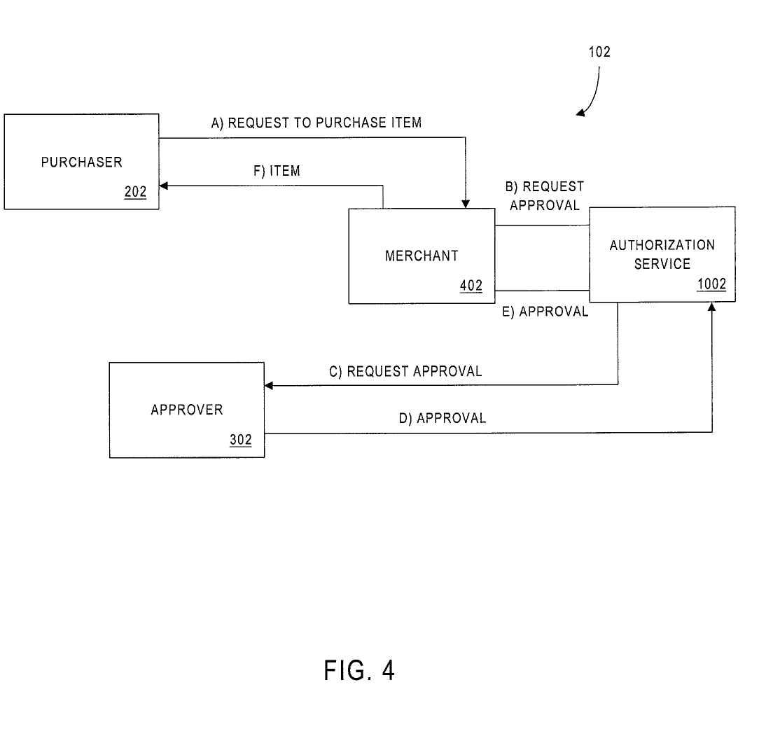

FIG. 4 is an information flow diagram of a transaction 102 performed according to an embodiment of the present invention wherein an authorization service 1002 is associated with a plurality of merchants. Note that many of the features of the this embodiment (e.g., the types of information that may trigger a request for authorization) are similar to those described in detail above with respect to the consumer approver embodiment.

At (A), a purchaser 202 provides a request to purchase an item to a merchant 402. For example, a child may attempt to purchase a book from the merchant 402 using an account associated with his or her parents (e.g., a merchant account or a credit card account).

According to this embodiment, the merchant 402 requests approval for the transaction from an authorization service 1002 at (B). The authorization service 1002 may be, for example, associated with a number of different merchants 402.

The authorization service 1002 then attempts to authorize the transaction by requesting approval for the transaction from an approver 302 at (C). For example, the authorization service 1002 may attempt to authorize the transaction by sending information about the transaction to a child's parent (e.g., describing the item and indication a cost associated with the item). If the approver 302 does not approve the transaction, the authorization service 1002 may prevent the item from being provided to the purchaser.

If the approver 302 provides an indication of approval to the authorization service 1002 at (D), the authorization service 1002 relays the approval to the merchant 402 at (E). The merchant 402 then proceeds with the transaction by providing the item to the purchaser 202 at (F). For example the merchant 402 may provide a book to a child. According to another embodiment, the approver 302 instead transmits the indication of approval directly to the merchant 402 or to the purchaser 202 (e.g., who in turn provides the indication to the merchant 402).

In this way, an approver 302 (e.g., a small business) can let a purchaser 202 (e.g., an employee) initiate transactions while still having some control over the transactions that are completed. Moreover, both the approver 302 and the merchant can 402 can support this control without installing an elaborate workflow system (e.g., the process is instead handled by the authorization service 1002).

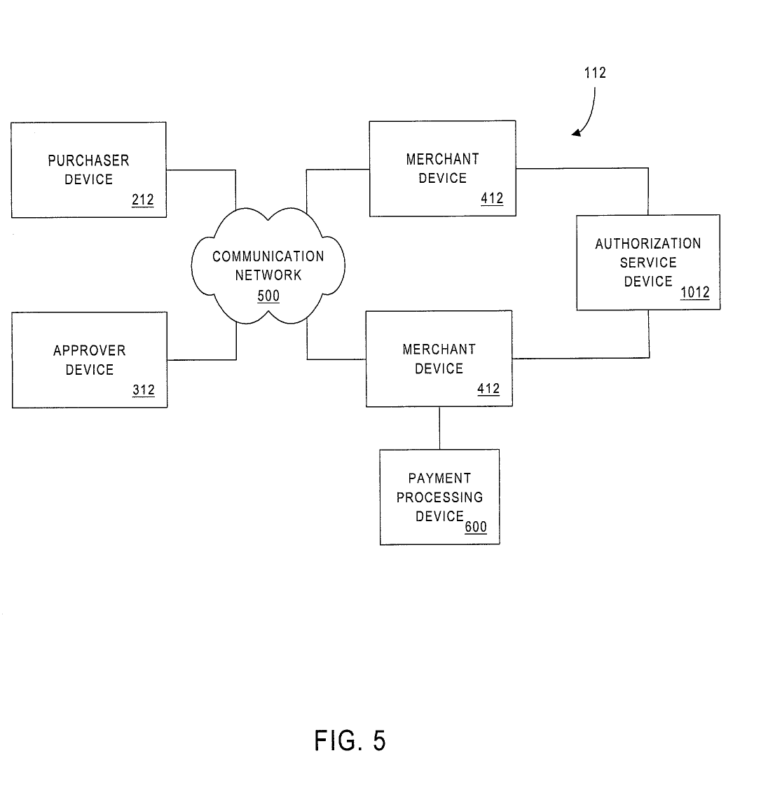

FIG. 5 is a block diagram of an transaction system 112 according to the embodiment of the present invention shown in FIG. 4. The transaction system 112 includes an authorization service device 1012 in communication with multiple merchant devices 412.

In one embodiment of the present invention, a purchaser device 212 communicates with a remote, Web-based merchant device 412 (e.g., a server) via a communication network 500 such as the Internet. For example, a purchaser may use his or her PC to access a Web site associated with a merchant. The purchaser device 212 then transmits a request to purchase an item to a merchant device 412.

According to this embodiment, the authorization service device 1012 receives a request to authorize the transaction from the merchant device 412. The authorization service device 1012 then determines an approver and/or an approver device 312 associated with the purchaser and/or the purchaser device 212.

The authorization service device 1012 arranges for information about the transaction to be transmitted to the approver device 312. If the authorization service device 1012 receives an indication of approval from the approver device 312, the approval is related to the merchant device 412 and the item is provided to the purchaser.

According to another embodiment, the approver device 312 instead provides an indication of approval directly to the merchant device 412 or the purchaser device 212. For example, the approver device 312 may transmit a transaction identifier and password (or other secure information ) to the merchant device 412.

The authorization service device 1012 and/or the merchant device 412 can also arrange for the merchant to receive payment in exchange for the item via a payment processing device 600.

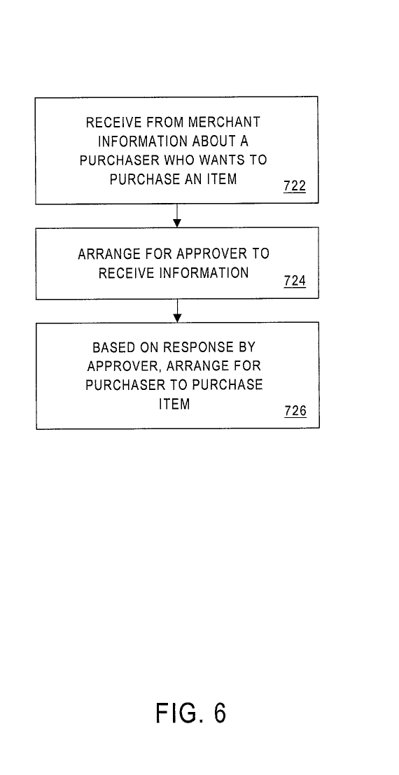

FIG. 6 is a flow chart of a method that may be performed according to the embodiment of the present invention shown in FIG. 4. The method may be performed, for example, by the authorization service device 1012.

At 722, the authorization service device 1012 receives from a merchant information about a purchaser who wants to purchase an item. The authorization service device 1012 arranges for an approver, associated with the purchaser, to receive information about the request at 724. Based on a response by the approver, the authorization service device 1012 arranges for the item to be provided to the purchaser at 726.

Credit Card Authorizer Embodiment

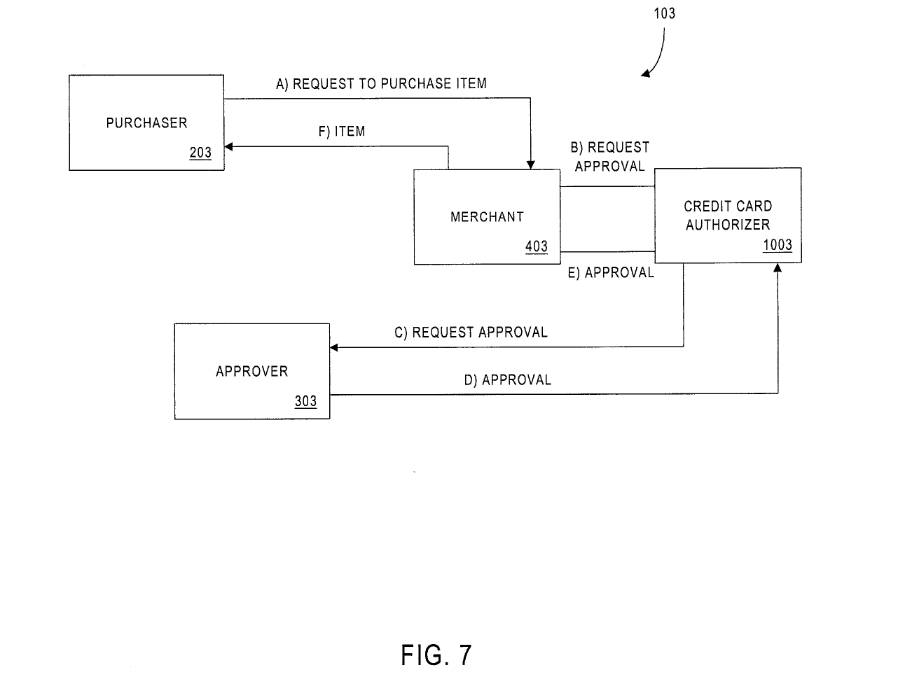

FIG. 7 is an information flow diagram of a transaction 103 performed according to an embodiment of the present invention wherein a credit card authorizer 1003 facilitates a transaction. Note that the credit card authorizer 1003 may comprise any type of payment device including, for example, a debit card authorizer, a band authorizer, or a digital payment protocol authorizer. Also note that many of the features of the this embodiment (e.g., the types of information that may trigger a request for authorization) are similar to those described in detail above with respect to the consumer approver embodiment.

At (A), a purchaser 203 provides a request to purchase an item to a merchant 403. For example, a child may attempt to purchase a book from the merchant 403 using an account associated with his or her parents (e.g., a merchant account or a credit card account).

According to this embodiment, the merchant 403 requests approval for the transaction from a credit card authorizer 1003 at (B). For example, the merchant 403 may swipe the purchaser's credit card through a card reader and transmit a request to approve the transaction to the credit card authorizer 1003 as is typically done. At this point, the credit card authorizer 1003 may perform the usual steps to validate the transaction (e.g., making sure that a credit card number has not expired and/or that an account has sufficient credit to cover the transaction).

The credit card authorizer 1003 may then verify that the purchaser's credit card account has sufficient credit. If so, the credit card authorizer 1003 attempts to authorize the transaction by requesting approval from an approver 303 at (C). For example, the credit card authorizer 1003 may attempt to authorize the transaction by sending information about the transaction to a child's parent (e.g., describing the item and indicating a cost associated with the item). If the approver 303 does not approve the transaction, the credit card authorizer 1003 denies authorization for the transaction.

If the approver 303 provides an indication of approval to the credit card authorizer 1003 at (D), the credit card authorizer 1003 relays the approval to the merchant 403 at (E). The merchant 403 then proceeds with the transaction by providing the item to the purchaser 203 at (F).

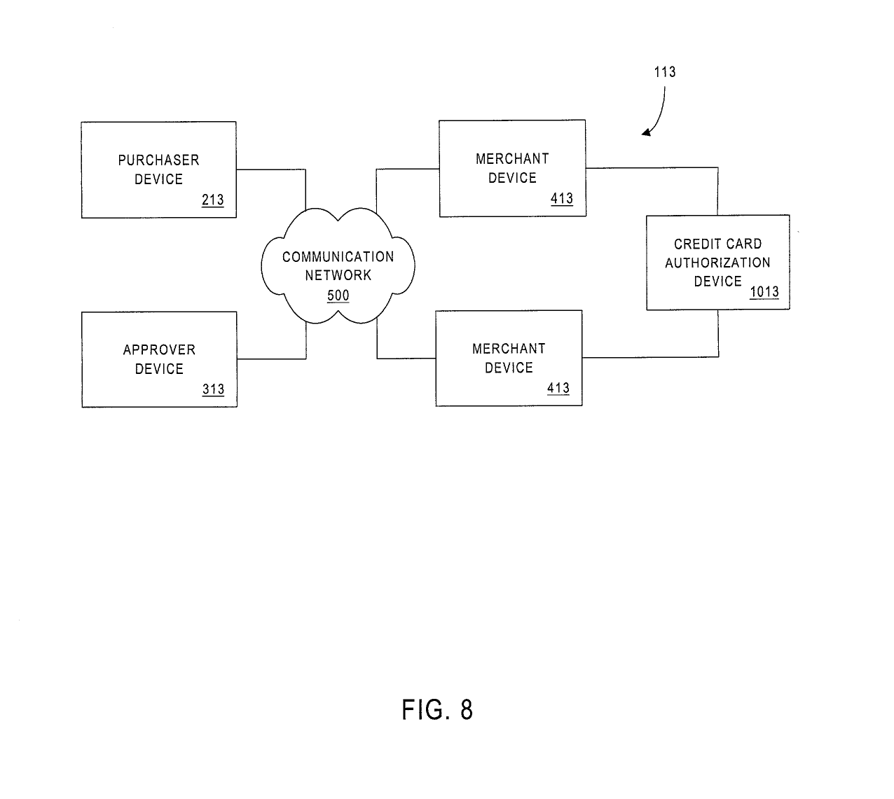

FIG. 8 is a block diagram of an transaction system 113 according to the embodiment of the present invention shown in FIG. 7. The transaction system 113 includes a credit card authorization device 1013 in communication with multiple merchant devices 413.

In one embodiment of the present invention, a purchaser device 213 communicates with a remote, Web-based merchant device 413 (e.g., a server) via a communication network 500 such as the Internet. For example, a purchaser may use his or her PC to access a Web site associated with a merchant. The purchaser device 213 then transmits a request to purchase an item to a merchant device 413.

According to this embodiment, the credit card authorization device 1013 receives a request to authorize the transaction from the merchant device 413. The credit card authorization service device 1013 then determines an approver and/or an approver device 313 associated with the purchaser and/or the purchaser device 213.

The credit card authorization device 1013 arranges for information about the request to be transmitted to the approver device 313. If the credit card authorization device 1013 receives an indication of approval from the approver device 313, the approval is related to the merchant device 413 and the item is provided to the purchaser.

The credit card authorization device 1013 also arranges for the merchant to receive payment in exchange for the item.

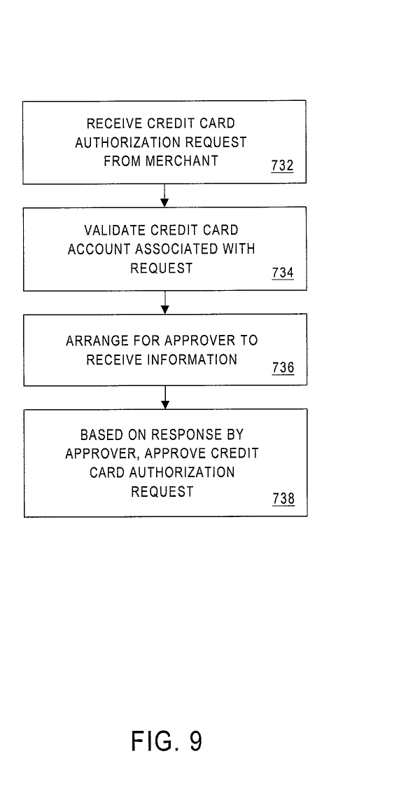

FIG. 9 is a flow chart of a method that may be performed according to the embodiment of the present invention shown in FIG. 7. The method may be performed, for example, by the credit card authorization device 1013.

At 732, the credit card authorization device 1013 receives from a merchant information about a purchaser who wants to purchase an item, such as a credit card authorization request. At 734, the credit card authorization device 1013 validates a credit card account associated with the request. For example, the credit card authorization device 1013 may make sure that the account exists (e.g., and has not expired) and that the account has sufficient credit to cover the requested transaction.

The credit card authorization device 1013 may then access information associated with the credit card account to determine an approver associated with the purchaser. The credit card authorization device 1013 arranges for the approver to receive information about the request at 736. Based on a response by the approver, the credit card authorization device 1013 approves the credit card authorization request at 738 to arrange for the item to be provided to the purchaser.

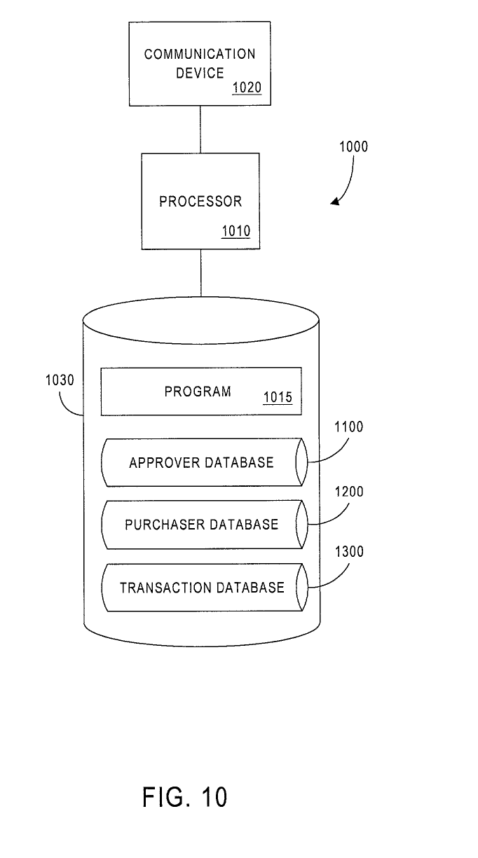

An example of an authorization device that may be used in connection with the transaction systems 111, 112, 113 discussed herein will now be described in detail with respect to FIG. 10.

Authorization Device

FIG. 10 illustrates an authorization device 1000 that is descriptive of the authorization devices shown, for example, in FIGS. 2, 5, and 8 according to some embodiments of the present invention. The authorization device 1000 comprises a processor 1010, such as one or more INTEL® Pentium® processors, coupled to a communication device 1020 configured to communicate via a communication network (not shown in FIG. 10). The communication device 1020 may be used to communicate, for example, with the various purchaser devices, approver devices, merchant devices, and/or payment devices described herein.

The processor 1010 is also in communication with a storage device 1030. The storage device 1030 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 1030 stores a program 1015 for controlling the processor 1010. The processor 1010 performs instructions of the program 1015, and thereby operates in accordance with the present invention. For example, the processor 1010 may receive a request by a consumer purchaser to purchase an item from a merchant. The processor 1010 may then arrange for a consumer approver associated with the consumer purchaser to receive information about the request.

According to another embodiment, the processor 1010 receives information associated with a request by a purchaser to purchase an item from one of a plurality of merchants. The processor 1010 may then arrange for an approver associated with the purchaser to receive information about the request (e.g., by transmitting the information to the approver).

As used herein, information may be “received” by or “transmitted” to, for example: (i) the authorization device 1000 from a purchaser device, an approver device, a merchant device, and/or a payment device; or (ii) a software application or module within the authorization device 1000 from another software application, module, or any other source.

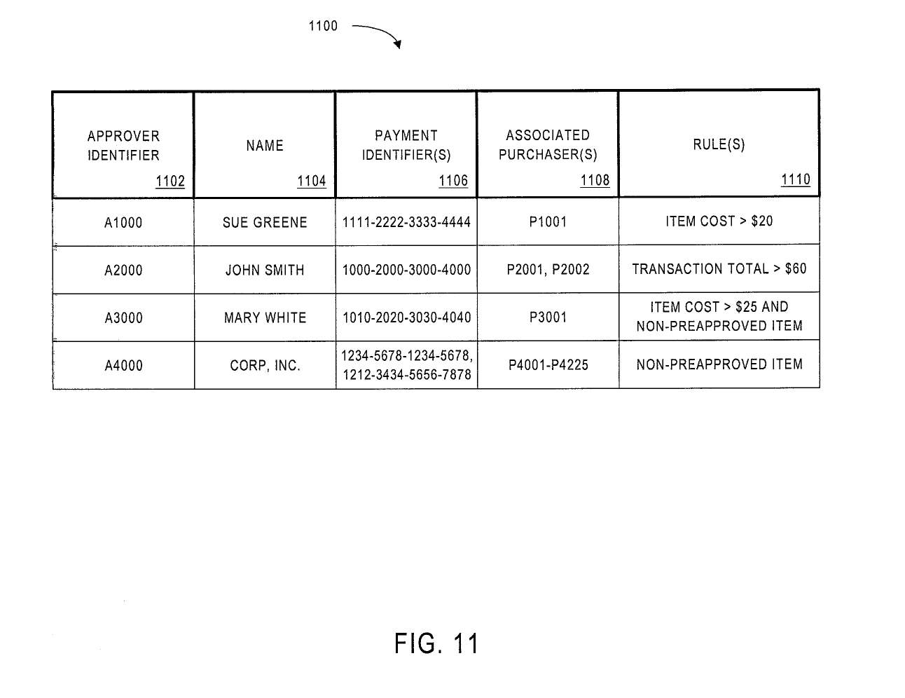

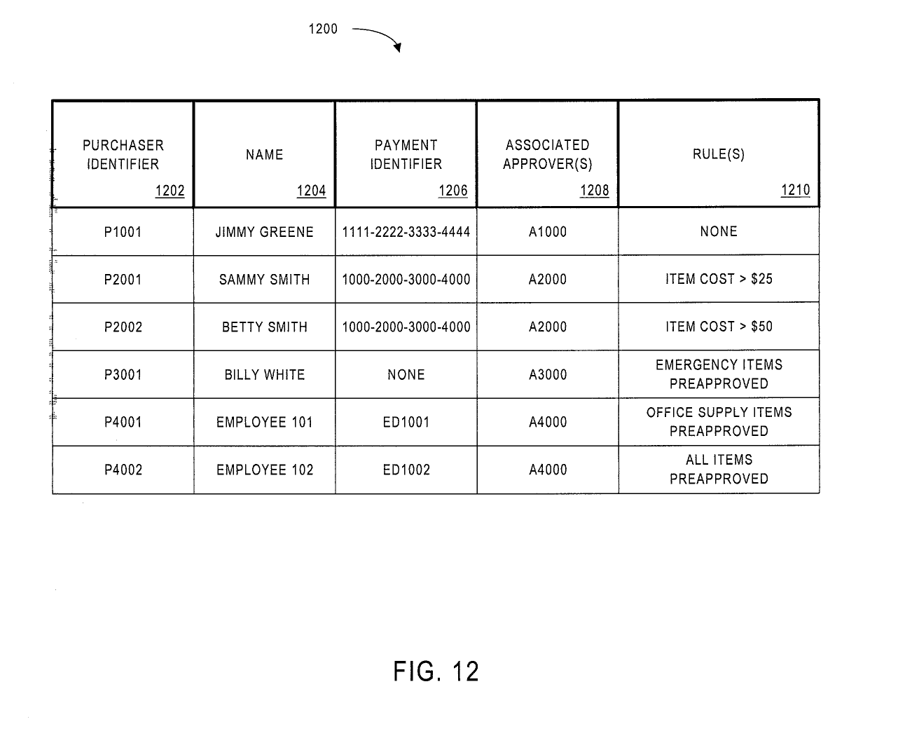

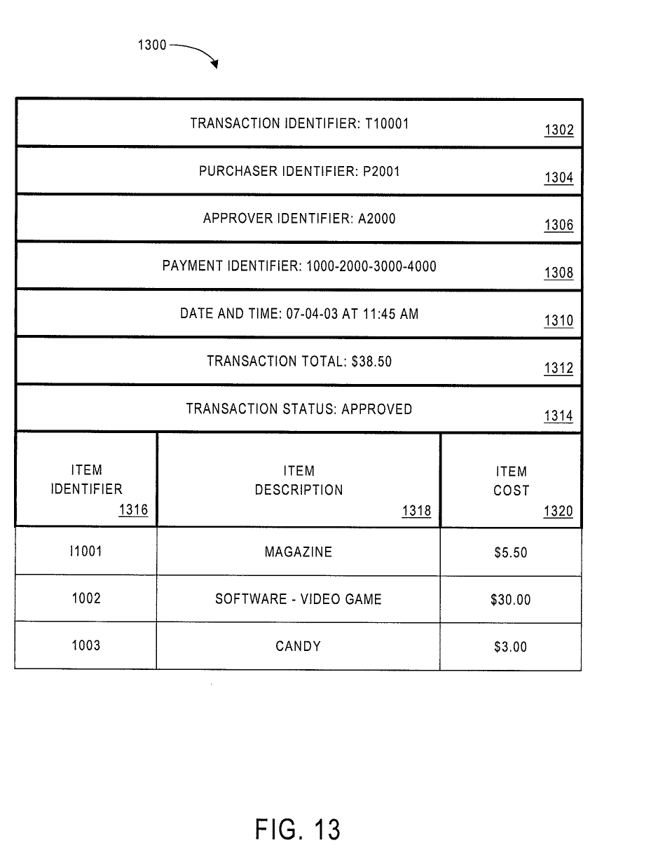

As shown in FIG. 10, the storage device 1030 also stores an approver database 1100 (described with respect to FIG. 11), a purchaser database 1200 (described with respect to FIG. 12), and a transaction database 1300 (described with respect to FIG. 13). Examples of databases that may be used in connection with the transaction systems 111, 112, 113 discussed herein will now be described in detail with respect to FIGS. 11 through 13. The illustration and accompanying description of the databases presented herein are exemplary, and any number of other database arrangements could be employed besides those suggested by the figures.

Approver Database

Referring to FIG. 11, a table represents the approver database 1100 that may be stored at the authorization device 1000 according to an embodiment of the present invention. The table includes entries identifying parties from whom approval may be required before a transaction will be completed. The table also defines fields 1102, 1104, 1106, 1108, 1110 for each of the entries. The fields specify: an approver identifier 1102, a name 1104, one or more payment identifiers 1106, one or more associated purchasers 1108, and one or more rules 1110. The information in the approver database 1100 may be created and updated, for example, when an approver sets up and/or modifies an account with a merchant, an authorization service, and/or a credit card service.

The approver identifier 1102 may be, for example, an alphanumeric code associated with a party from whom approval may be required before a transaction will be completed. The name 1104 and payment identifiers 1106 may represent, for example, the approver's name and one or more credit card numbers associated with the approver, respectively.

The associated purchasers 1108 may comprise identifiers representing purchasers who might require an approval from the approver before they are allowed to receive items via a transaction system. The rules 1110 may include a rule that will be evaluated to determine if a given transaction requires approval by the approver. For example, as shown by the first entry in the approver database 1100, the approval of “A1000” is required before “P1001” will be allowed to receive an item that costs more than twenty dollars.

Purchaser Database

Referring to FIG. 12, a table represents the purchaser database 1200 that may be stored at the authorization device 1000 according to an embodiment of the present invention. The table includes entries identifying parties who may need an approval before a transaction will be completed. The table also defines fields 1202, 1204, 1206, 1208, 1210 for each of the entries. The fields specify: a purchaser identifier 1202, a name 1104, a payment identifier 1206, one or more associated approvers 1208, and one or more rules 1210. The information in the approver database 1200 may be created and updated, for example, when an approver sets up or modifies an account with a merchant, an authorization service, and/or a credit card service.

The purchaser identifier 1202 may be, for example, an alphanumeric code associated with a party who may need an approval before a transaction will be completed. The purchaser identifiers 1202 may be based on, or associated with, the associated purchasers 1108 stored in the approver database 1100. The name 1204 and payment identifiers 1206 may represent, for example, the name of the purchaser and one or more credit card numbers associated with an approver, respectively.

The associated approvers 1208 may comprise identifiers representing approvers from whom approval might be required before a transaction is completed. The associated approvers 1208 may be based on, or associated with, the approver identifiers 1102 stored in the approver database 1100.

The rules 1210 may include a rule that will be evaluated to determine if a given transaction requires approval by the approver. For example, as shown by the second entry in the purchaser database 1100, the approval of “A2000” is required before “P2001” will be allowed to receive an item that costs more than twenty five dollars.

Transaction Database

Referring to FIG. 13, a table represents a record in the transaction database 1300 that may be stored at the authorization device 1000 according to an embodiment of the present invention. The database includes records representing transactions performed via a transaction system. The information in the transaction database 1300 may be created and updated, for example, when a purchaser receives an item via the transaction system.

As shown in FIG. 13, each record indicates a transaction identifier 1302 and a purchaser identifier 1304 associated with the transaction and the purchaser, respectively. The purchaser identifier 1304 may be based on, or associated with, the purchaser identifier 1202 stored in the purchaser database 1200. Each record also indicates an approver identifier 1306 that represents a party who approved the transaction. The approver identifier 1306 may be based on, or associated with, the approver identifier 1102 stored in the approver database 1100.

Each record also includes a payment identifier 608 associated with the transaction. The payment identifier 608 may comprise, for example, a credit card, debit card or bank account number (e.g., a checking account number) or digital payment protocol information. The payment identifier 608 may be used, for example, to arrange for a merchant to receive payment in exchange for an item. The date and time 1310 indicates when the transaction occurred, and the transaction total 1312 indicates an amount the merchant will receive in connection with the transaction. A transaction status 1314 indicates whether the transaction has been “approved” or “not approved.”

The table also defines fields 1316, 1318, 1320 for each record. The fields specify: an item identifier 1316, an item description 1318, and an item cost 1320.

The item identifier 1316 indicates an item that was request by and/or provided to a purchaser. The item description 1318 describes the item or items being purchased. The item cost 1320 indicates a cost that the particular item. Note that the transaction total 1312 may be calculated by adding each item cost 1320 associated with the transaction.

Some or all of the information in the transaction database 1300 may be evaluated by an authorization device 1000 to determine if an approval from an approver is required before the transaction will be completed. Moreover, some or all of the information in the transaction database 1300 may be transmitted to an approver when seeking such an approval. For example, the item description 1318 and the item cost 1320 may be transmitted to the approver.

Transaction Method

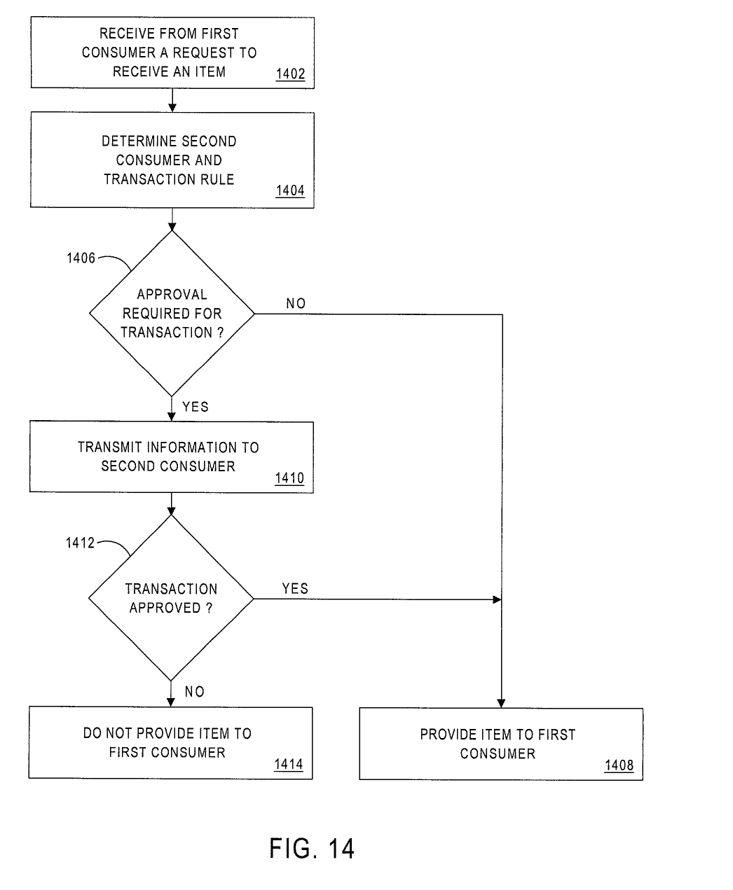

FIG. 14 is a flow chart of a computer implemented method for facilitating a transaction. The method may be performed, for example, by an authorization device 1000.

At 1402, the authorization device 1000 receives a request by a first consumer to receive an item from an merchant. The request may be, for example, received by the merchant via the Internet. At 1404, a second consumer associated with the first consumer and an appropriate transaction rule are determined. For example, information in the approver database 1100 and the purchaser database 1200 may be evaluated to determine the appropriate second consumer and transaction rule.

If approval is not required for the transaction at 1406, the authorization device 1000 arranges for the item to be sold or provided to the first consumer at 1408. If approval is required for the transaction at 1406, the authorization device 1000 transmits information to the second consumer at 1410.

If the second consumer approves the transaction at 1412, the authorization device 1000 arranges for the item to be sold or provided to the first consumer at 1408. If the second consumer does not approve the transaction at 1412, the authorization device 1000 arranges for item to not be sold or provided to the first consumer at 1414.

### EXAMPLES

The following examples will illustrate some embodiments of the present invention. Consider Alice and her son Bobby. Alice arranges to have separate (but related) accounts established for her and Bobby with an online book merchant. At that time, she indicates that Bobby is allowed to purchase as many educational books as he wants along with an additional thirty dollars worth of books each month without approval.

Bobby then uses his account to purchase twenty five dollars worth of non-educational books from the online merchant. Because he is below the threshold amount established by Alice, the books are delivered to Bobby without approval from Alice. The next day, however, Bobby attempts to purchase an additional ten dollars worth of non-educational books. He is now above the threshold amount, and the online merchant sends an electronic mail message to Alice requesting her approval of the additional purchase. Alice approves the additional purchase via the merchant's Web site and the additional books are also delivered to Bobby.

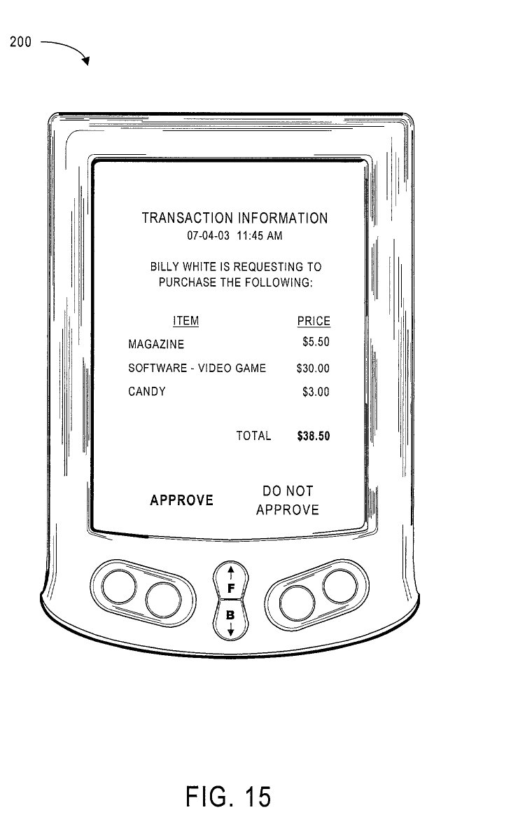

As another example, Alice and her other son Billy each bring a PDA to a local shopping mall. Alice configures Billy's PDA so that he can use the PDA during the next three hours to purchase up to twenty dollars worth of items. If he attempts to purchase more than twenty dollars worth of items, his PDA (or a merchant device) transmits information to Alice's PDA requesting her approval. FIG. 15 illustrates a PDA 200 displaying transaction information according to this embodiment.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although most of the embodiments described herein are associated with a purchaser requesting an item, according to another embodiment a party may instead request to receive a payment. For example, a parent may arrange to allow his or her child to withdraw up to forty dollars per week from an Automated Teller Machine (ATM) device. When the child attempts to exceed this amount, a message is displayed on the parent's two-way pager requesting his or her approval.

Similarly, although some embodiments described herein are associated with a party attempting to purchase or receive an item, according to another embodiment a party may instead attempt to sell or provide an item. For example, a child may attempt to sell an item via an online auction service. In this case, the online auction service may transmit information about the auction to the child's parent (e.g., to obtain the parent's approval).

Another embodiment is directed to a reporting device as opposed to an authorization device. For example, a merchant may simply report information about items that are being (or have been purchased) by a child to his or her parents. In this case, the parent may, according to one embodiment, indicate that future transactions by the child should be prevented.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating a transaction via a merchant authorization device associated with a merchant, comprising:
receiving at the merchant authorization device a request by a consumer purchaser to purchase an item from the merchant; and
arranging via the merchant authorization device for a consumer approver associated with the consumer purchaser to receive information about the request.

2. The method of claim 1, wherein at least one of said receiving and said arranging comprises exchanging information with a remote consumer device via a communication network.

3. The method of claim 2, wherein the remote consumer device comprises at least one of: (i) a personal computer, (ii) a portable digital assistant, (iii) a telephone, (iv) a wireless telephone, (v) a kiosk, and (vi) an automated teller machine device.

4. The method of claim 2, wherein the communication network comprises at least one of: (i) the Internet, (ii) a public network, (iii) a proprietary network, (iv) a wireless network.

5. The method of claim 2, wherein said receiving is performed via a first communication network and said arranging is performed via a second communication network.

6. The method of claim 1, wherein said arranging comprises transmitting the information associated with the request to a remote consumer approver device.

7. The method of claim 1, further comprising:
receiving account information from the consumer approver before receiving the request from the consumer purchaser, wherein the account information indicates at least one of: (i) the consumer purchaser, and (ii) a transaction rule.

8. The method of claim 1, further comprising:
determining the consumer approver based on at least one of: (i) the consumer purchaser, (ii) a payment identifier, and (iii) a merchant account associated with the consumer purchaser, and (iv) a merchant account associated with the consumer approver.

9. The method of claim 1, further comprising:
evaluating transaction information associated with the request to determine if the consumer approver will receive the information associated with the request.

10. The method of claim 9, wherein the transaction information comprises at least one of: (i) a consumer purchaser identifier, (ii) a consumer approver identifier, (iii) information received from the consumer approver, (iv) a transaction rule, (v) an item price, (vi) a total price associated with a transaction, (vii) a total price associated with a plurality of transactions, and (viii) an item identifier.

11. The method of claim 1, further comprising:
receiving an indication of approval from the consumer approval; and
based on the received indication of approval, providing the item to the consumer purchaser.

12. The method of claim 11, further comprising:
arranging for the merchant to receive payment in exchange for item from at least one of: (i) the consumer purchaser, and (ii) the consumer approver.

13. A computer implemented method of facilitating a transaction via a merchant authorization device associated with a merchant, comprising:
receiving at the merchant authorization device a request by a first consumer to receive an item from the merchant, the request being received via a communication network;
determining a second consumer based on the first consumer;
determining a transaction rule;
evaluating information associated with the transaction based on the transaction rule;
based on said evaluation, transmitting information about the request from the merchant authorization device to a second consumer;
receiving an indication of approval from the second consumer; and
arranging for the item to be provided to the first consumer based on the received indication of approval.

14. A merchant authorization device associated with a merchant, comprising:
a processor; and
a storage device in communication with said processor and storing instructions adapted to be executed by said processor to:
receive a request by a consumer purchaser to purchase an item from the merchant; and
arrange for a consumer approver associated with the consumer purchaser to receive information about the request.

15. The apparatus of claim 14, wherein said storage device further stores at least one of: (i) a consumer approver database, (ii) a consumer purchaser database, and (iii) a transaction database.

16. The apparatus of claim 14, further comprising:
a communication device coupled to said processor and adapted to communicate with at least one of: (i) a consumer purchaser device, (ii) a consumer approver device, and (iii) a payment device.

17. A medium storing instructions adapted to be executed by a processor to perform a method of facilitating a transaction via a merchant authorization device associated with a merchant, said method comprising:
receiving at the merchant authorization device a request by a consumer purchaser to purchase an item from the merchant; and
arranging via the merchant authorization device for a consumer approver associated with the consumer purchaser to receive information about the request.

18. A method of facilitating a transaction via an authorization service device associated with a plurality of merchants, comprising:
receiving at the authorization service device information associated with a request by a purchaser to purchase an item from one of the plurality of merchants; and
arranging for an approver associated with the purchaser to receive information about the request.

19. The method of claim 18, wherein the purchaser comprises a consumer purchaser and the approver comprises a consumer approver.

20. The method of claim 18, wherein the purchaser comprises a business purchaser and the approver comprises a business approver.

21. The method of claim 18, said receiving comprises receiving the information from one of: (i) a device associated with the purchaser, (ii) a device associated with the merchant, and (iii) a payment processing device.

22. The method of claim 18, further comprising:
transmitting authorization information to a device associated with the merchant.

23. An authorization service device associated with a plurality of merchants, comprising:
a processor; and
a storage device in communication with said processor and storing instructions adapted to be executed by said processor to:
receive information associated with a request by a purchaser to purchase an item from one of the plurality of merchants; and
arrange for an approver associated with the purchaser to receive information about the request.

24. A medium storing instructions adapted to be executed by a processor to perform a method of facilitating a transaction via an authorization service device associated with a plurality of merchants, said method comprising:
receiving at the authorization service device information associated with a request by a purchaser to purchase an item from one of the plurality of merchants; and
arranging for an approver associated with the purchaser to receive information about the request.

25. A method of facilitating a transaction via a payment processing device associated with a plurality of merchants, comprising:
receiving at the payment processing device information associated with a request by a purchaser to purchase an item from one of the plurality of merchants; and
transmitting information associated with the request to an approver associated with the purchaser.

26. The method of claim 25, wherein the payment processing device comprises a credit card processing device.

27. The method of claim 25, further comprising:
verifying a payment account associated with the request prior to said transmitting.

28. The method of claim 25, wherein the purchaser comprises a consumer purchaser and the approver comprises a consumer approver.

29. The method of claim 25, wherein the purchaser comprises a business purchaser and the approver comprises a business approver.

30. A payment processing device, comprising:
a processor; and
a storage device in communication with said processor and storing instructions adapted to be executed by said processor to:
receive information associated with a request by a purchaser to purchase an item from one of a plurality of merchants associated with the payment processing device; and
transmit information associated with the request to an approver associated with the purchaser.

31. A medium storing instructions adapted to be executed by a processor to perform a method of facilitating a transaction via a payment processing device associated with a plurality of merchants, said method comprising:
receiving at the payment processing device information associated with a request by a purchaser to purchase an item from one of the plurality of merchants; and
transmitting information associated with the request to an approver associated with the purchaser.
